(19) United States
(12) Patent Application Publication
(10) Pub. No.: US 2002/0105105 A1
(43) Pub. Date: Aug. 8, 2002

(54) Process for making an eva-based foam article

(76) Inventor: Chao-Jih Liu, Taichung Hsien (TW)

Correspondence Address: James A. Kushman, Brooks & Kushman P.C., 22nd Floor, 1000 Town Center, Southfield, MI, 48075-1351, US

(21) Appl. No.: 09/776,844

(22) Filed: Feb. 5, 2001

(51) Int. Cl. B29C 44/06

(52) U.S. Cl. 264/45.5

(57) ABSTRACT

A process for making an EVA-based foam article includes the steps of: prefoaming an EVA-based foamable material to form a preformed foam; placing the preformed foam into a mold cavity of a mold; further foaming the preformed foam to form an intermediate foam body; and rapidly cooling the mold to room temperature to permit the intermediate foam body to form a foam product that has a skin portion and an inner portion enclosed by the skin portion and having a density less than that of the skin portion.

### BACKGROUND OF THE INVENTION

1. Field of the Invention

This invention relates to a process for making an EVA-based foam article, more particularly to a process for making an EVA-based foam article that has a loose inner portion and a dense skin portion enclosing the inner portion.

2. Description of the Related Art

A conventional plastic foam article is normally prepared by a process that involves melting of a foamable plastic material in an oven and transferring the foamable plastic melt into a mold cavity of a mold for undergoing foaming and molding processes.

In order to provide elastic and not too soft characteristics, the thus-formed product is normally relatively dense, and has a uniform density.

The aforesaid transfer of the plastic melt from the oven to the mold tends to render the same to be contaminated with dust or air, thereby adversely affecting the quality of the product. Moreover, the aforesaid process results in flashes formed on the surface of the product, which also adversely affects the quality of the product.

### SUMMARY OF THE INVENTION

Therefore, the object of the present invention is to provide a process for making an EVA-based foam article that is capable of overcoming the aforementioned drawbacks.

According to the present invention, a process for making an EVA-based foam article is proposed. The process comprises the steps of: prefoaming an EVA-based foamable material to form a preformed foam; placing the preformed foam into a mold cavity of a mold; further foaming the preformed foam at a foaming temperature between 160° C. to 190° C. to allow the same to expand in the mold cavity and to form into an intermediate foam body that has a shape conforming to that of the mold; and rapidly cooling the mold to room temperature to permit the intermediate foam body to form a foam product that has a skin portion and an inner portion that is enclosed by the skin portion and that has a density less than that of the skin portion.

### BRIEF DESCRIPTION OF THE DRAWING

In the drawings which illustrate an embodiment of the invention,

FIG. 1 is a perspective cut-away view to illustrate a cross-section of a hockey stick made by a process according to this invention;

FIG. 2 is a perspective cut-away view to illustrate a cross-section of a baseball bat made by the process of this invention; and

FIG. 3 is a perspective cut-away view to illustrate a cross-section of a U-shaped article made by the process of this invention.

### DETAILED DESCRIPTION OF THE PREFERRED EMBODIMENT

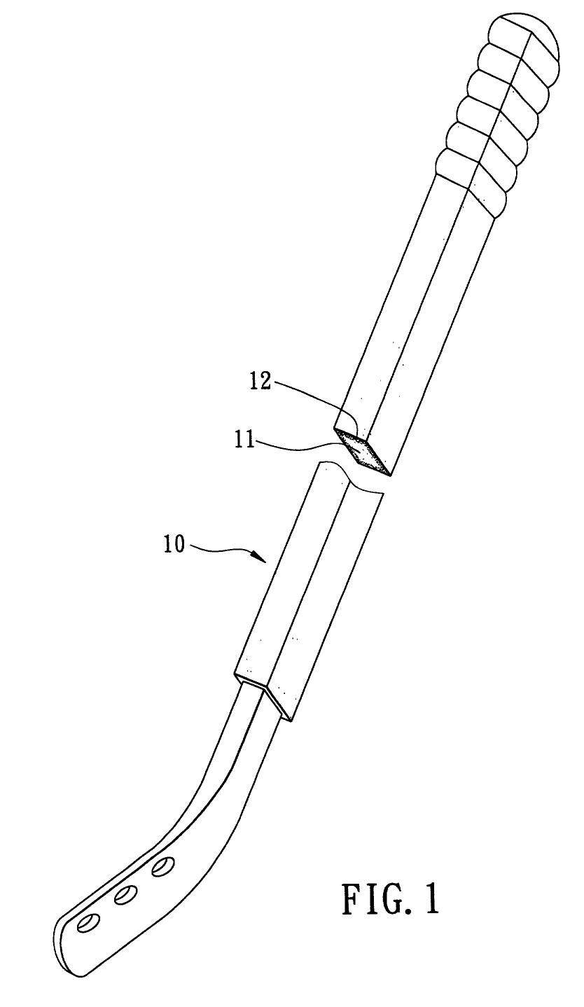

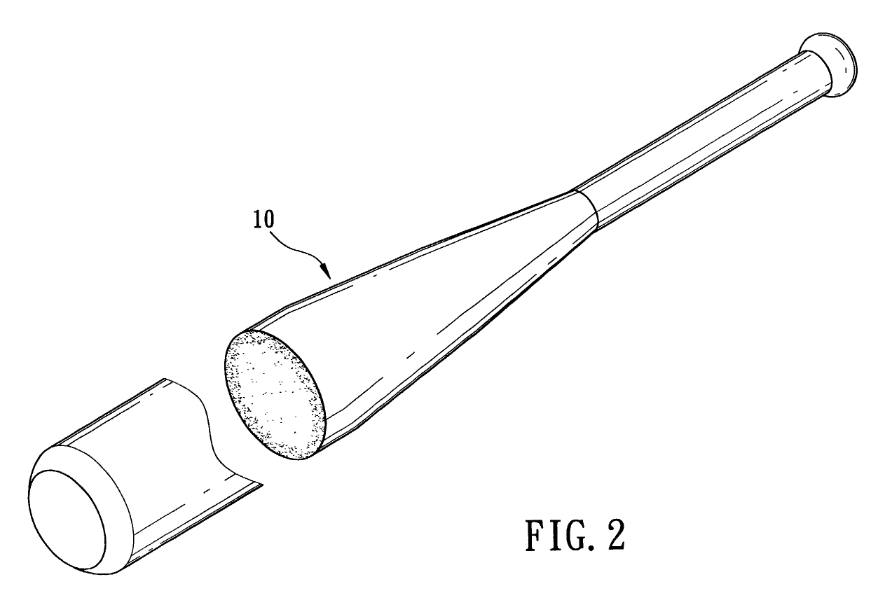

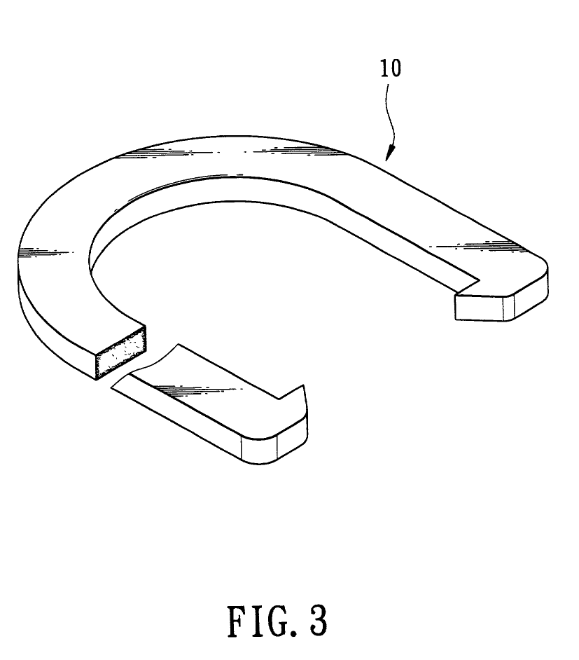

FIGS. 1 to 3 illustrate different EVA-based foam articles 10 made by a process according to the present invention. These foam articles 10 are respectively a hockey stick, a baseball bat, and a U-shaped toy. Each of the articles 10 has a loose inner portion 11 and a dense skin portion 12 that encloses the inner portion 11 and that has a density much greater than that of the inner portion 11.

The process of this invention includes the steps of: prefoaming an EVA-based foamable material to form a preformed foam; placing the preformed foam into a mold cavity of a mold (not shown); further foaming the preformed foam at a foaming temperature of about 180° C. for about 30 seconds to allow the same to expand in the mold cavity and to form into an intermediate foam body; and subsequently rapidly cooling the mold to room temperature so that foaming reaction at an outer surface of the intermediate foam body, which is in contact with an inner wall of the mold (not shown), is substantially terminated while foaming reaction of an inner portion of the intermediate foam body, which is enclosed by the outer surface, continues. As a consequence, a dense foam layer, which forms the skin portion 12 of the foam article 10, is formed at and adjacent to the outer surface of the intermediate foam body due to continuous expansion of the inner portion of the intermediate foam body. The time period for forming the dense foam layer preferably lasts for at least about 30 seconds to obtain the foam article 10 such that the skin portion 12 of the foam article 10 has a density that is at least two times larger than that of the inner portion 11 of the foam article 10.

Since the inner portion 11 of the foam article 10 is much less dense than the skin portion 12, the process of this invention can use less plastic foamable material to produce the foam article 10 while maintaining similar elastic characteristic as possessed by the prior art for the skin portion 12 of the foam article 10. Moreover, since the skin portion 12 of the foam article 10 is formed upon rapid cooling of the mold due to termination of the foaming reaction at the skin portion 12, the flash problem as encountered in the prior art can be eliminated. Furthermore, since the material (i.e., the preformed foam,) transferred to the mold for further foaming is in a solid state in the process of this invention, the contamination problem associated with the prior art can also be eliminated.

With the invention thus explained, it is apparent that various modifications and variations can be made without departing from the spirit of the present invention. It is therefore intended that the invention be limited only as recited in the appended claims.

I claim:

1. A process for making an EVA-based foam article, comprising the steps of:
prefoaming an EVA-based foamable material to form a preformed foam;
placing said preformed foam into a mold cavity of a mold;
further foaming said preformed foam at a foaming temperature between 160° C. to 190° C. to allow the same to expand in said mold cavity and to form into an intermediate foam body that has a shape conforming to that of said mold; and
rapidly cooling said mold to room temperature to permit said intermediate foam body to form a foam product that has a skin portion and an inner portion that is enclosed by said skin portion and that has a density less than that of said skin portion.

2. The process of claim 1, wherein the density of said skin portion is at least two times larger than that of said inner portion.
